(19) United States
(12) Patent Application Publication
(10) Pub. No.: US 2003/0123619 A1
(43) Pub. Date: Jul. 3, 2003

(54) Voice authenticated terminal registration

(76) Inventors: Steve J. McKinnon, Cary, NC (US); William Clyde Prentice Dalrymple, Cary, NC (US); Jeong Min Kim, Allen, TX (US)

Correspondence Address: WITHROW & TERRANOVA, P.L.L.C., P.O. BOX 1287, CARY, NC, 27512, US

(21) Appl. No.: 10/034,275

(22) Filed: Dec. 28, 2001

(51) Int. Cl. H04M 1/64

(52) U.S. Cl. 379/88.02

(57) ABSTRACT

A mechanism is provided allowing a user to initiate registration of his telephony address with another terminal in an efficient and user-friendly manner. The user initiates a call to a registration service to establish an audio connection with his terminal. Once the audio connection is established, the user may audibly provide a registration command and his identity to facilitate registration of the user at the terminal for future calls directed to the user's telephony address. From the command and identity, the registration service will recognize that registration is being requested, determine the identification of the user, and authenticate the user. The user is authenticated by deriving a voiceprint from the user and comparing it with a reference voiceprint that was previously derived from the user. Assuming that the user is authenticated, the service will effect registration, such that future calls for the telephony address are terminated at the terminal.

### FIELD OF THE INVENTION

The present invention relates to packet-switched telephony, and in particular to registration and authentication to use telephony terminals.

### BACKGROUND OF THE INVENTION

Packet-switched telephony, such as that facilitated over the Internet, provides numerous benefits over traditional circuit-switched telephone networks. One such benefit allows users to have one telephony address, which may be a telephony address, uniform resource locator, or network address, that is used to receive calls at any number of terminals facilitating voice communications. In essence, the user need only have his telephony address registered in association with a terminal to receive calls. Typically, a proxy server is used with packet-switched telephony to register telephony addresses with corresponding terminals and to assist in establishing communications with those terminals using the telephony address.

Although there is great flexibility in routing calls directed to a given telephony address to various terminals, registering the terminals in association with the telephony addresses has proven to be difficult and less than user friendly. When registering a terminal with a telephony address or address, there is a need to associate the terminal with the telephony address, as well as authenticate the user attempting the registration. Without authentication, third parties could effectively re-route calls without proper authorization.

Accordingly, there is a need for a secure and user-friendly way to allow a user to have calls routed to a different terminal. There is a further need to facilitate registration of a new terminal in association with the user's telephony address and to facilitate such registration only after authenticating the user.

### SUMMARY OF THE INVENTION

The present invention provides a mechanism for allowing a user to initiate registration of his telephony address with another terminal in an efficient and user-friendly manner. The user may initiate a call to a registration service, which will establish an audio connection with the terminal that the user is using. Once the audio connection is established, the user may audibly provide a registration command and his identity to facilitate registration of the user at the terminal for future calls directed to the user's telephony address. From the command and identity, the registration service will recognize that registration is being requested, determine the identification of the user, and authenticate the user. The user is authenticated by deriving a voiceprint from the user and comparing it with a reference voiceprint that was previously derived from the user. Assuming that the user is authenticated, the service will effect registration of the terminal in association with the user's telephony address at a proxy, or like call control device, such that future calls for the telephony address are terminated at the identified terminal.

The terminal can be identified by information in the initial call signaling used to establish the call between the terminal and the registration service. In such an embodiment, the registration is for the terminal initiating the call. Alternatively, the user may identify a selected terminal when providing the registration command and his identity. Accordingly, the terminal registered in association with the user's telephony address may be the terminal that the user is currently using, or a terminal that the user plans to use in the future.

In one embodiment, the service is broken into a registration service function and a voice user interface (VUI) service function. These functions may be provided in the same or different devices. In either case, the registration service function will typically control the process and interact with the VUI service function to establish an audio connection between the terminal and the VUI, as well as initiate the user identification and authentication process. The VUI will preferably include the necessary software to convert speech to text in order to obtain the registration command and identity of the user, as well as a voiceprint of the user to compare with the reference voiceprint. Once the VUI service function authenticates the user, a message is sent to the registration service function to indicate that the user is identified and authenticated, and triggers the registration service function to register the user's telephony address in association with the identified terminal. Accordingly, the registration service function will use the user's name to identify the telephony address for the user and send the telephony address along with the terminal address to effect registration at the proxy or like device.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a communication environment according to one embodiment of the present invention.

FIG. 2 is a communication flow diagram for initially registering a user with a telephone system according to one embodiment of the present invention.

FIG. 3 is a call flow diagram for changing the registration associated with a user from one terminal to another according to one embodiment of the present invention.

FIG. 4 is a block representation of a proxy server constructed according to the present invention.

FIG. 5 is a block representation of a voice user interface according to the present invention.

FIG. 6 is a block representation of a registration server according to the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is very similar to call forwarding from a user perspective, with the exception that operation is controlled via voice commands and incorporates the use of voiceprint matching to identify and authenticate the user. The invention facilitates the registration of a user's telephony address with a terminal being used or to be used by the user. Registration is user-friendly and secure, and greatly facilitates user mobility.

The present invention incorporates voice recognition to recognize user commands, and uses voiceprints to authenticate the user. In operation, the user will call in to a service and vocally provide his identity and a command, which will typically relate to associating the user with a new terminal facilitating telephony communications. The service will identify the user, authenticate the user, and respond to user commands. Preferably, the service will recognize both the user and a command based on a single voice command provided by the user. From the voice command, a voiceprint is recovered and compared with a stored voiceprint associated with the user. Assuming that the voiceprints match, the user is authenticated and any recognized commands are used to facilitate further action. Authentication of the user may be supplemented with a code, such as a password. Although the system will preferably be configured to recognize the spoken code, the service could be configured to use digits entered via the terminal.

In general, a user will enroll with the service and provide a series of voiceprints consisting of various phrases, such as user name, password, sequences of numbers, and the like. Preferably, initiation of the enrolling system is automatic when users are first introduced to the system or initially use the system. For example, if a user dials in to the service for the first time, the service will determine if the user is a new user or an existing user. If it is determined that a new user is calling, the enrollment process will begin automatically, and the user will be guided through the enrollment process to provide the necessary information to facilitate recognition of commands, as well as authenticate the user by obtaining a voiceprint. The voiceprint is biometric indicia, which will be stored and used to compare against subsequent responses to authenticate the user.

Once a user is enrolled, all calls directed to the user's telephony address will terminate at the terminal provided in the enrollment. When the user travels to another location and desires that calls be directed to the terminal in the new location, the user may simply activate the terminal and contact the registration service to initiate re-registration. The user may have to dial the registration service, or the terminal may be equipped with a button or key sequence to automatically contact the service.

Once connected to the service, the user may simply say, “Register John Smith,” assuming that the user is named John Smith, to effect registration. The service recognizes the command REGISTER and identifies the user by recognizing his spoken name, John Smith. The service takes a voiceprint from the spoken phrase and compares it with the user's voiceprint stored during the enrollment process. If the voiceprints match, the user is authenticated, and the service registers the terminal in association with the user and the user's telephony address. If necessary, a supplemental password may be used for further authentication. The service can preferably identify the new terminal based on identification provided in the underlying messages used to establish connection with the service. Once the user is authenticated, the service may cancel all previous registrations for other terminals and register the user in association with the new terminal, so that all calls directed to his number will terminate at the terminal in the user's new location. Alternatively, a new registration may be added to the previous registrations.

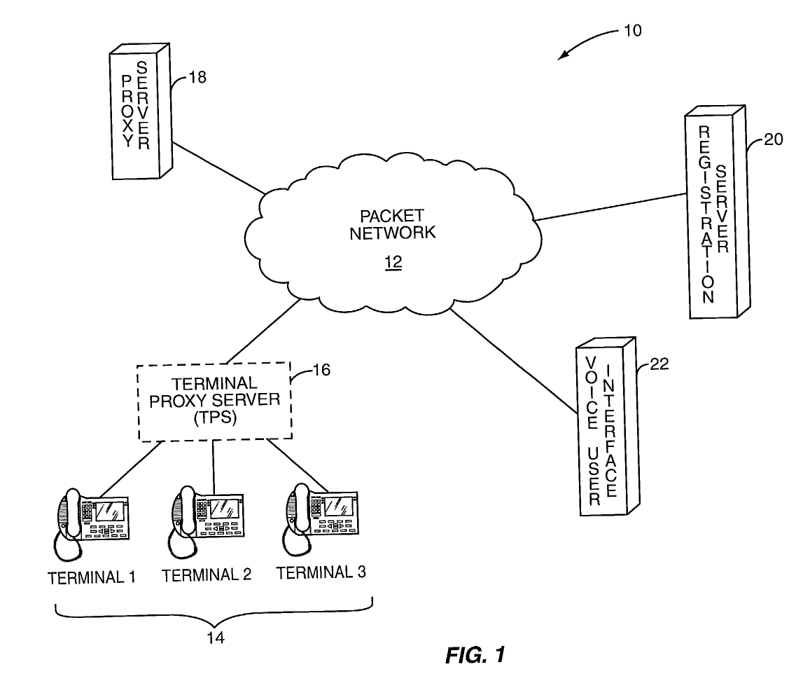

With reference to FIG. 1, a communication environment 10 according to one embodiment of the present invention is illustrated. The communication network 10 includes a packet network 12 facilitating packet-switched communications, and in particular, facilitating communications with any number of terminals 14, which are individually identified as terminals 1 through 3. Preferably, these terminals 14 are configured to provide voice communications over the packet network 12. Depending on the sophistication of the terminals 14, a terminal proxy server (TPS) 16 may be necessary to act as a liaison between the packet network 12 and the individual terminals 14. The use of a terminal proxy server 16 is generally determined based on the capability of the terminals 14 to communicate with the network 12 directly as well as the desire to configure the terminal proxy server 16 and the terminals 14 in a server-client configuration, wherein the terminal proxy server 16 acts as the interface for the terminals 14 to the packet network 12. In many environments, a separate proxy server 18 is used to facilitate call signaling and the establishment of media sessions for associated devices, such as the terminals 14. In general, the terminals 14 will register with the proxy server 18 to provide their addresses, communication capabilities, and addressing aliases.

In one embodiment of the present invention, a registration server 20 and a voice user interface (VUI) 22 are incorporated to facilitate voice-based interactions with the user via the terminals 14, provide authentication, and effect changes in registrations for the terminals 14 at the proxy server 18. Although the concepts of the present invention are applicable to various communication environments and related protocols, the present invention is preferably implemented using the Session Initiation Protocol (SIP). The specification for SIP is provided in the Internet Engineering Task Force's RFC 2543: Session Initiation Protocol Internet Draft, which is incorporated herein by reference in its entirety.

In general, a SIP proxy, such as may be provided by proxy server 18, may facilitate media sessions between any number of endpoints, such as terminals 14. These endpoints may support any one or combination of data, audio, and voice media sessions, depending on the configuration of the respective endpoints. Although not inclusive, endpoints may take the form of a personal computer (PC), telephone, personal digital assistant (PDA), and the like.

A SIP endpoint is generally capable of running an application, which is referred to as a user agent (UA), capable of facilitating media sessions using SIP. User agents register their ability to establish sessions with a SIP proxy by sending “REGISTER” messages to the SIP proxy. The REGISTER message informs the SIP proxy of the SIP universal resource locator (URL) that identifies the user agent to the SIP network. The REGISTER message also contains information about how to reach specific user agents over the SIP network, by providing the IP address and port that the user agent will use for SIP sessions.

When a user agent wants to establish a session with another user agent, the user agent initiating the session will send an INVITE message to the SIP proxy and specify the targeted user agent in the TO header of the INVITE message. Identification of the user agent takes the form of a SIP URL. In its simplest form, the URL is represented by a number or “<username>@<domain>,” such as “johnsmith@nortelnetworks.com.” The SIP proxy will use the SIP URL in the TO header of the message to determine if the targeted user agent is registered with the SIP proxy. Generally, the user name is unique within the name space of the specified domain.

If the targeted user agent has registered with the SIP proxy, the SIP proxy will forward the INVITE message directly to the targeted user agent. The targeted user agent will respond with a 200 OK message, and a session between the respective user agents will be established as per the message exchange required in the SIP specification. Media capabilities are passed between the two user agents of the respective endpoints as parameters embedded within the session setup messages, such as the INVITE, 200 OK, and acknowledgement (ACK) messages. The media capabilities are typically described using the Session Description Protocol (SDP). Once respective endpoints are in an active session with each other and have determined each other's capabilities, the specified media content may be exchanged during an appropriate media session.

The present invention uses the registration capabilities of SIP proxies to maintain the current location registry of the user. For the following description, assume that the SIP messages takes place either directly with the terminal 14 or that each terminal 14 is represented by the TPS 16. The communication flows illustrate communications directly between the proxy server 18 and the terminals 14 for clarity. Those skilled in the art will recognize that the TPS 16 may act as a liaison between the proxy server 18 and the terminals 14. Although the terminals 14 may take on any number of configurations capable of facilitating voice communications, the disclosed embodiment incorporates Nortel Networks Limited's i2004 SIP-enabled handsets.

In operation, the proxy server 18 acts as a SIP proxy and is responsible for accepting registration requests from the terminals 14. The terminals 14 will register with the proxy server 18 and specify contact addresses where they can be reached. When calls get routed through the proxy server 18, the proxy server 18 is responsible for forwarding the call on to the appropriate address based on the registration data.

The registration server 20 is responsible for performing the functional logic for interacting with the VUI 22 and the proxy server 18. The registration server 20 facilitates connections with users using a published SIP registration service number. Once connected, the registration server 20 can interact with the VUI 22 to obtain user identification and action requests, which will be discussed in greater detail below. Once the information is obtained, the registration server 20 will interact with the proxy server 18 to effect appropriate registration requests to cancel previous registrations and add new ones.

The VUI 22 is responsible for establishing an audio connection with a terminal 14 when prompted to do so by the registration server 20. The VUI 22 will proceed to interact with the terminal 14 to acquire audio information from the user, as will be described below. Once the information is obtained, the VUI 22 will reply back to the registration server 20 with the information gathered from the user. The VUI 22 will support voice recognition and may provide text-to-speech to facilitate interactions with the user in an audible form. Importantly, the proxy server 18, registration server 20 and VUI 22 are represented as separate physical devices, but may be implemented in software in separate or integrated platforms.

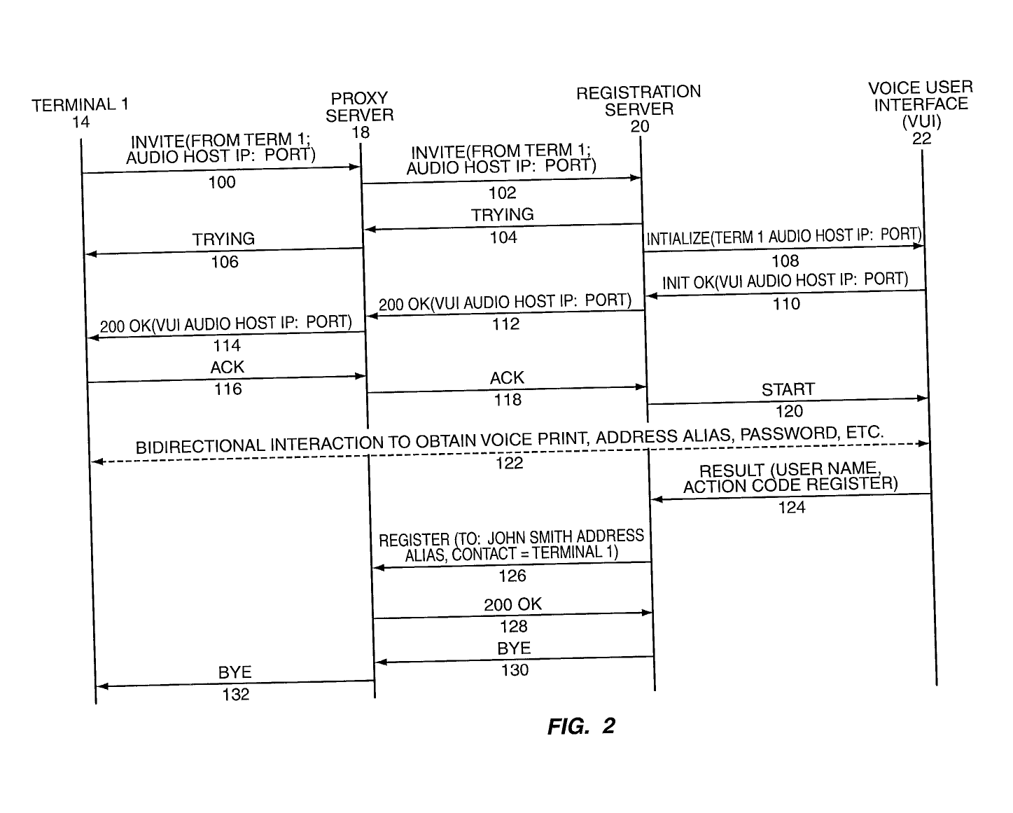

The call flow of FIG. 2 illustrates an initial enrollment process for terminal 1. Assume that the user is named John Smith, whose extension at terminal 1 is x1111. Initially, John Smith will initiate registration by dialing a number or pressing a button on terminal 1 to initiate enrollment. Accordingly, terminal 1 will send an INVITE message directed to the registration server 20 via the proxy server 18 (steps 100 and 102). The INVITE message will include addressing information for terminal 1 and the necessary audio connection information, represented as HOST IP: PORT, from the session description protocol (SDP) portion of the INVITE message. The registration server 20 will extract the addressing and audio connection information and send a TRYING message to terminal 1 via the proxy server 18 (steps 104 and 106). At this point, terminal 1 is ready and anticipating an audio connection.

Next, the registration server 20 will send an INITIALIZE message to the VUI 22, including the audio connection information for terminal 1 to determine where audio packets should be sent (step 108). The VUI 22 will also prepare to receive packets, preferably using the Real-Time Protocol (RTP), at a defined port. Further, the VUI 22 will send a response, such as an INIT OK message, to the registration server 20 (step 110). The INIT OK message may contain the necessary codec information and an address identifying where the RTP audio packets must be sent to be properly received by the VUI 22. In response, the registration server 20 will send a SIP 200 OK message back to terminal 1 via the proxy server 18 containing the audio information (HOST IP: PORT) in the SDP body of the message (steps 112 and 114). In standard SIP fashion, terminal 1 will respond with an acknowledgement (ACK) to the registration server 20 via the proxy server 18 (steps 116 and 118). Upon receiving the acknowledgement, the registration server 20 may send a START message to the VUI 22 to initiate audible communications with the user via terminal 1 (step 120). At this point, both the VUI 22 and terminal 1 are aware of each other's address information and are prepared to send and receive packets containing audio information (step 122).

Once the audio connection is established, the VUI 22 will interact with the user to obtain a voiceprint for biometrically authenticating the user based on his voice characteristics and identity. The VUI 22 may also obtain codes, such as passwords for additional security, and any other information necessary for voice recognition or to train the software for voice recognition. In essence, the initial enrollment should provide enough information for the VUI 22 to obtain a voiceprint for and identification of the user. Additional information for speech recognition or training will be determined by the sophistication of the speech recognition software. For example, simple embodiments may require a user to speak actual words, phrases, and commands, whereas more sophisticated systems may require a user to repeat various phrases to facilitate a more generalized voice recognition interaction. Although the VUI 22 may receive identification for terminal 1 from the user, it is preferred for the registration server 20 to receive identification for the communicating terminal 14 from the underlying messaging used to establish the connection initiating enrollment. Thus, the registration server 20 will already have the identification of terminal 1 from the original INITIALIZE message (see step 108) and not need to get it through the VUI 22.

Once the VUI 22 has determined an identification for the user, a RESULT message is sent back to the registration server 20 providing the user's name and an action code identifying an action for the registration server 20 to take (step 124). In this case, the action code corresponds to registering John Smith as a new user to the service. The registration server 20 will create a registration for the user, preferably in association with an alias representing the telephony address, such as an internet address (<user>@<domain>.com) or a number record.

Next, the registration server 20 will send a REGISTER message to the proxy server 18 to register terminal 1 in association with the user John Smith, preferably by using the alias (x1111) associated with John Smith (step 126). In response, the proxy server 18 will send a 200 OK message to the registration server 20 (step 128), which will send a BYE message to terminal 1 via the proxy server 18 to complete the enrollment process (steps 130 and 132). At this point, John Smith is registered in association with the telephony address x1111 and terminal 1. Accordingly, all calls terminating at x1111 are directed to terminal 1.

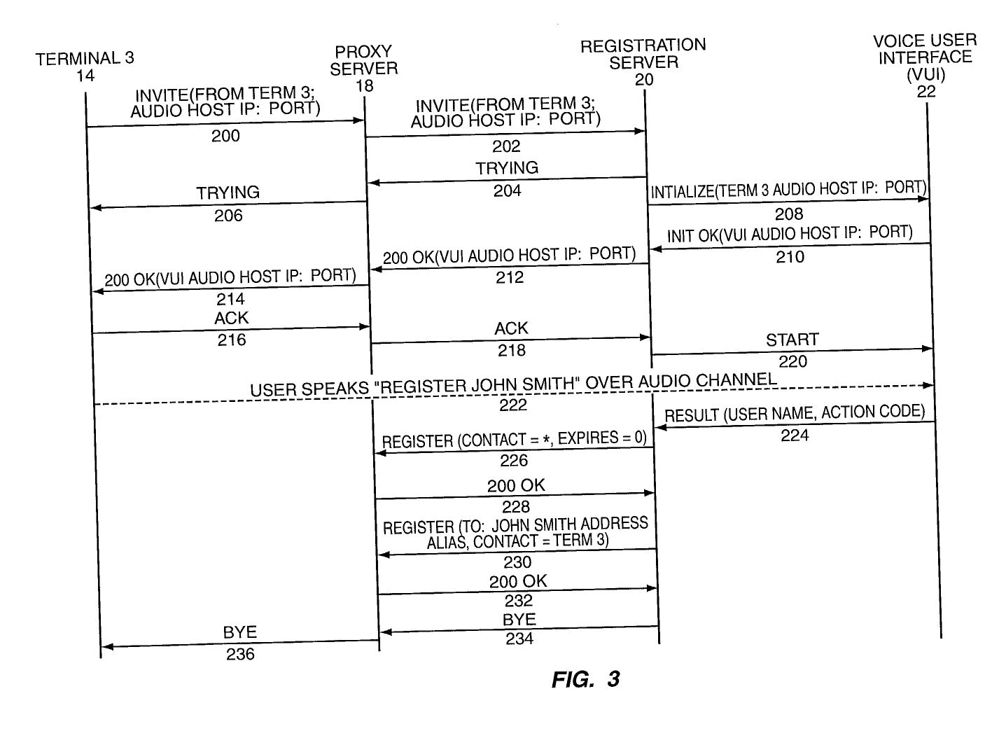

At this point, assume that John Smith has moved to a location proximate to terminal 3 and desires to have all calls terminating at x1111 to be received at terminal 3. John Smith must effectively cancel the previous registration associating terminal 1 with x1111 and register terminal 3 with x1111. The communication flow of FIG. 3 illustrates a re-registration process according to one embodiment of the present invention.

When John Smith arrives at terminal 3, he will pick up the handset and dial an extension associated with the registration server 20 or select a button automatically configured to initiate a connection to the registration server 20. Accordingly, an INVITE message is sent from terminal 3 to the registration server 20 via the proxy server 18 (steps 200 and 202). The registration server 20 will extract and save the addressing information for terminal 3, from the “FROM” field of the INVITE message, as well as the audio connection information (HOST IP: PORT) from the SDP body. At this point, terminal 3 is ready for an audio connection. The registration server 20 will send a TRYING message to terminal 3 via the proxy server 18 (steps 204 and 206), as well as send an INITIALIZE message to the VUI 22 to pass on terminal 3's addressing and audio connection information (step 208). The VUI 22 will then have sufficient information to send audio packets to terminal 3 and prepare it to receive audio packets from terminal 3. The VUI 22 will respond by sending a message (INIT OK) to the registration server 20 containing its audio information, so that the registration server 20 can forward the information back to terminal 3 so the terminal will know where to send audio packets (step 210). Accordingly, the registration server 20 will provide the audio information to terminal 3 using a 200 OK message, which is forwarded to terminal 3 via the proxy server 18 (steps 212 and 214). Terminal 3 will respond by sending an acknowledgement message to the registration server 20 via the proxy server 18 (steps 216 and 218).

Upon receiving the acknowledgement, the registration server 20 will send a START message to the VUI 22 indicating that the VUI 22 should begin to gather and process the user information via its speech resources (step 220). At this point, the VUI 22 and terminal 3 know about each other's audio connection information and are prepared to transmit and receive audio. Accordingly, audio communications can go back and forth between the VUI 22 and terminal 3.

Assume that the VUI 22 is configured to expect a command followed by the user's name to initiate a change in registration. Accordingly, the user may speak the phrase, “Register John Smith” at terminal 3 (step 222), and the VUI will process the received audio to identify a command, the user's identity, and a voiceprint for the spoken phrase. The speech recognition capabilities of the VUI 22 will determine that the command spoken is a REGISTER command, and that the user's identity is John Smith. The voiceprint associated with the phrase, “Register John Smith” is compared with the voiceprint stored in association with John Smith during enrollment. Assuming that the voiceprints match, John Smith is authenticated, and the process continues. If the user is not authenticated, or if additional information is required for authentication, the VUI 22 may request additional information to further facilitate a match in voiceprints and/or obtain an audible or other type of password to compare with information stored in association with John Smith. If authentication fails, the user is identified and the process ends.

Assuming that John Smith is authenticated and the command is properly detected, the VUI 22 will send a RESULT message to the registration server 20 identifying the authenticated name of John Smith and an action code, which corresponds to registration (step 224). At this point, the VUI 22 can end the session with John Smith, clear its resources, and wait for the next initialization message from the registration server 20.

The registration server 20 will receive the RESULT message from the VUI 22 and determine that a registration is required for the identified user name. The registration server 20 will look up the user name, John Smith, and retrieve the alias (telephony address) stored during enrollment, which is used for the registration address of record. Once the user is found in the database, the registration server 20 may cancel previous registrations for the alias and register the alias in association with terminal 3 at the proxy server 18. This may be accomplished by having the registration server 20 send a REGISTER message to the proxy server 18 having CONTACT=*and EXPIRES=0 to cancel the previous registrations for John Smith (step 226). The proxy server 18 will respond with a 200 OK message (step 228), which will trigger the registration server 20 to send another REGISTER message to the proxy server 18 identifying the address of terminal 3 (step 230), which was obtained from the FROM header of the initial INVITE message (see steps 200 and 202). The proxy server 18 registers John Smith in association with terminal 3 and replies with a 200 OK message (step 232). The registration server 20 will complete the process by initiating a BYE message to terminal 3 via the proxy server 18 (steps 234 and 236). At this point, the telephony address for John Smith is registered at terminal 3. All calls directed to x1111 are now passed to terminal 3 via the proxy server 18.

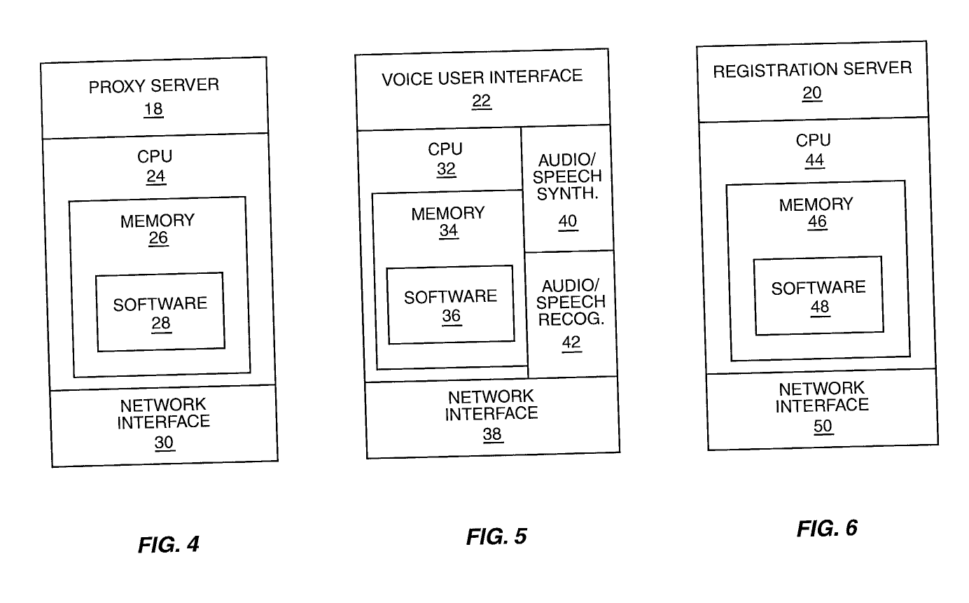

An exemplary proxy server 18 is depicted in FIG. 4. The proxy server 18 will preferably include a central processing unit (CPU) 24 having sufficient memory 26 to store the necessary software 28 and associated data for operation. The CPU 24 is associated with a network interface 30 to facilitate packet-switched communications.

FIG. 5 is a block representation of the VUI 22, which will typically include a CPU 32 with memory 34 and the requisite software 36 to control operation. The CPU 32 is also associated with a network interface 38 for communicating with network devices, such as the registration server 20 and, directly or indirectly, the terminal 14. The VUI 22 is preferably configured with an audio or speech synthesizer 40 and audio or speech recognition software or hardware 42. The speech synthesizer 40 may be used to generate audio instructions and messages for the users of the terminals 14. Notably, the VUI 22 may use pre-recorded audio to provide messages to the user, or may convert textual content to speech. Those skilled in the art will recognize the various voice automation capabilities and functionalities compatible with the concepts of the present invention.

With reference to FIG. 6, an exemplary registration server 20 is illustrated having a CPU 44 with sufficient memory 46 to store the necessary software 48 and associated data for operation. The CPU 44 is associated with a network interface 50 to facilitate packet-switched communications.

Although the above embodiments focus on allowing a user to change registrations directly from a new terminal, the VUI 22 and registration server 20 may be configured to facilitate registration for a new terminal 14 at a different location. For example, this alternative allows a user to call the service and request the registration from terminal 2, but redirect calls to terminal 3. Accordingly, the user would speak the phrase, “Register John Smith at 555-1534.” The service would perform the action identification as well as identify and authenticate the user using voice pattern matching as described above. The service will then look for an explicit number that the user has spoken and use that as a number to which calls are redirected. If the user does not speak the new number, the service may default to the terminal 14 from which the user initiated the current call. Further, the spoken phrase may only include a command, wherein the voiceprint is used for identification and authentication.

Other enhancements are also possible, and include providing additional audio guidance and menus for guiding the user through the enrollment and re-registration requests. The service may be configured to allow users to effectively preempt the VUI's voice prompts to accelerate the service. This is especially useful for experienced users who already know how to use the system and do not need the prompts. Further, the registration server 20 and VUI 22 may be configured to process multiple requests at the same time.

Those skilled in the art will recognize improvements and modifications to the preferred embodiments of the present invention. All such improvements and modifications are considered within the scope of the concepts disclosed herein and the claims that follow.

What is claimed is:

1. A method for facilitating registration of a terminal for a user comprising:
a) establishing an audio connection with a user;
b) receiving audio information spoken by the user via the audio connection;
c) determining the identity of the user from the audio information;
d) deriving a current biometric voiceprint from the audio information;
e) comparing the current biometric voiceprint to a reference biometric voiceprint associated with the identification of the user; and
f) effecting registration of a telephony address for the user in association with a terminal if the current biometric voiceprint matches the reference voiceprint;
wherein incoming calls directed to the telephony address for the user are terminated at the terminal.

2. The method of claim 1 further comprising:
a) receiving a call signaling message adapted to establish the audio connection with the user and triggered by the user initiating the audio connection from the terminal, the call signaling message including a terminal identification for the terminal; and
b) obtaining the terminal identification from the call signaling message.

3. The method of claim 1 wherein the audio information includes information identifying the terminal.

4. The method of claim 1 wherein the audio information includes a command for triggering registration and the identity of the user.

5. The method of claim 4 wherein the audio information is provided in a single phrase and the biometric voiceprint is derived from the single phrase.

6. The method of claim 1 further comprising determining the telephony address based on the identification of the user.

7. The method of claim 1 wherein the step of effecting registration of the telephony address comprises effecting communications with a proxy supporting the terminal in a manner configured to register the terminal in association with the telephony address.

8. The method of claim 7 wherein the step of effecting registration of the telephony address comprises effecting communications with the proxy supporting the terminal in a manner configured to remove previous registrations associated with the terminal.

9. The method of claim 1 further comprising:
a) providing initial audio information from the user; and
b) deriving the reference biometric voiceprint from the initial audio information.

10. The method of claim 1 further comprising:
a) receiving a code from the user in association with the audio information; and
b) comparing the code received from the user with a reference code to further authenticate the user,
wherein the registration of the telephony address for the user further depends on the code from the user matching the reference code.

11. The method of claim 1 wherein the telephony address is at least one of the group consisting of a number, a uniform resource locator, and a communication address.

12. A system for facilitating registration of a terminal for a user comprising an interface and a control system adapted to:
a) establish an audio connection with a user;
b) receive audio information spoken by the user via the audio connection;
c) determine the identity of the user from the audio information;
d) derive a current biometric voiceprint from the audio information;
e) compare the current biometric voiceprint to a reference biometric voiceprint associated with the identification of the user; and
f) effect registration of a telephony address for the user in association with a terminal if the current biometric voiceprint matches the reference voiceprint;
wherein incoming calls directed to the telephony address for the user are terminated at the terminal.

13. The system of claim 12 wherein the audio information includes information identifying the terminal.

14. The system of claim 12 wherein the audio information includes a command for triggering registration and the identity of the user.

15. The system of claim 14 wherein the audio information is provided in a single phrase and the biometric voiceprint is derived from the single phrase.

16. The system of claim 12 further comprising:
a) providing initial audio information from the user; and
b) deriving the reference biometric voiceprint from the initial audio information.

17. The system of claim 12 further comprising:
a) receiving a code from the user in association with the audio information; and
b) comparing the code received from the user with a reference code to further authenticate the user,
wherein the registration of the telephony address for the user further depends on the code from the user matching the reference code.

18. The system of claim 12 wherein the telephony address is at least one of the group consisting of a number, a uniform resource locator, and a communication address.

19. A system for facilitating registration of a terminal for a user comprising at least one control system adapted to provide a registration service function and a voice user interface (VUI) service function,
a) the VUI service function adapted to:
i) establish an audio connection with a user in response to a request from the registration service;
ii) receive audio information spoken by the user via the audio connection, the audio information including identification of the user;
iii) determine the identity of the user from the audio information;
iv) derive a current biometric voiceprint from the audio information;
v) compare the current biometric voiceprint to a reference biometric voiceprint associated with the identification of the user; and
vi) send a response to the registration service function providing the identification of the user and authenticating the user; and
b) the registration service function adapted to register a telephony address for the user in association with a terminal if the current biometric voiceprint matches the reference voiceprint wherein incoming calls directed to the telephony address for the user are terminated at the terminal.

20. The system of claim 19 wherein the registration service function is further adapted to:
a) receive a call signaling message adapted to establish the audio connection with the user, the call signaling message including a terminal identification for the terminal; and
b) instructing the VUI service function to establish the audio connection with the user.

21. The system of claim 20 wherein the registration service function is further adapted to obtain the terminal identification from the call signaling message.

22. The system of claim 19 wherein the registration service function is further adapted to determine the telephony address based on the identification of the user.

23. The system of claim 19 wherein the registration service function is further adapted to register the telephony address by sending a registration message to a proxy supporting the terminal in a manner configured to register the terminal in association with the telephony address.

24. The system of claim 23 wherein the registration service function is further adapted to register the telephony address by sending a message to the proxy supporting the terminal in a manner configured to remove previous registrations associated with the terminal.

25. The system of claim 19 wherein the audio information includes information identifying the terminal.

26. The system of claim 19 wherein the audio information includes a command for triggering registration and the identity of the user.

27. The system of claim 26 wherein the audio information is provided in a single phrase and the biometric voiceprint is derived from the single phrase.

28. The system of claim 19 wherein the VUI service function is adapted to:
a) receive initial audio information from the user;
b) derive the reference biometric voiceprint from the initial audio information; and
c) store the reference biometric voiceprint.

29. The system of claim 19 wherein the VUI service function is adapted to:
a) receive a code from the user in association with the audio information; and
b) compare the code received from the user with a reference code to further authenticate the user,
wherein the registration of the telephony address for the user further depends on the code from the user matching the reference code.

30. The system of claim 19 wherein the telephony address is at least one of the group consisting of a number, a uniform resource locator, and a communication address.

31. A system for facilitating registration of a terminal for a user comprising:
a) means for establishing an audio connection with a user;
b) means for receiving audio information spoken by the user via the audio connection, the audio information including identification of the user;
c) means for determining the identity of the user from the audio information;
d) means for deriving a current biometric voiceprint from the audio information;
e) means for comparing the current biometric voiceprint to a reference biometric voiceprint associated with the identification of the user; and
f) means for effecting registration of a telephony address for the user in association with a terminal if the current biometric voiceprint matches the reference voiceprint;
wherein incoming calls directed to the telephony address for the user are terminated at the terminal.

32. The system of claim 31 further comprising:
a) means for receiving a call signaling message adapted to establish the audio connection with the user and triggered by the user initiating the audio connection from the terminal, the call signaling message including a terminal identification for the terminal; and
b) means for obtaining the terminal identification from the call signaling message.

33. The system of claim 31 wherein the audio information includes information identifying the terminal.

34. The system of claim 31 wherein the audio information includes a command for triggering registration and the identity of the user.

35. The system of claim 34 wherein the audio information is provided in a single phrase and the biometric voiceprint is derived from the single phrase.

36. The system of claim 31 further comprising means for determining the telephony address based on the identification of the user.

37. The system of claim 31 wherein the step of effecting registration of the telephony address comprises means for effecting communications with a proxy supporting the terminal in a manner configured to register the terminal in association with the telephony address.

38. The system of claim 37 wherein the means for effecting registration of the telephony address comprises means for effecting communications with the proxy supporting the terminal in a manner configured to remove previous registrations associated with the terminal.

39. The system of claim 31 further comprising:
a) means for providing initial audio information from the user; and
b) means for deriving the reference biometric voiceprint from the initial audio information.

40. The system of claim 31 further comprising:
a) means for receiving a code from the user in association with the audio information; and
b) means for comparing the code received from the user with a reference code to further authenticate the user,
wherein the registration of the telephony address for the user further depends on the code from the user matching the reference code.

41. The system of claim 31 wherein the telephony address is at least one of the group consisting of a number, a uniform resource locator, and a communication address.
